(19) United States
(12) Patent Application Publication
(10) Pub. No.: US 2006/0138032 A1
(43) Pub. Date: Jun. 29, 2006

(54) In-water discharging core and sterilizing water supplying system using said core

(76) Inventor: Anderson H Kim, Thoma River, NJ (US)

Correspondence Address: John W Renner;Renner Otto Boisselle & Sklar, 1621 Euclid Avenue, 19th floor, Cleveland, OH, 44115, US

(21) Appl. No.: 10/542,216

(22) PCT Filed: Jan. 17, 2004
(86) PCT No.: PCT/KR04/00075

§ 371 Date: Jul. 14, 2005

(30) Foreign Application Priority Data
Jan. 17, 2003 (KR) 10-2003-0003186
Nov. 11, 2003 (KR) 10-2003-0079527

(51) Int. Cl. B01D 21/30

(52) U.S. Cl. 210/143; 210/110; 210/257.1; 210/243; 204/665; 210/660; 204/661

(57) ABSTRACT

An underwater discharging core that is equipped with a pair of the platinum plate meshes is developed to produce the sterilized water. The underwater discharging cells are designed based on the concept of the imaginary wire meshes of “Virtual Meshed Points” to maximize the sterilizing effect and operating efficiency. Thus, it is possible to offer the excellent quality of sterilized water by adopting the sterilized water generator utilizing the underwater discharge core and a sterilized water supply System utilizing the sterilized water generator.

### 1. TECHNICAL FIELD

The present invention is related to an underwater discharging core equipped with a pair of the platinum plate meshes made of conductive material and its application to the sterilized water supply system.

### 2. BACKGROUND ART

Generally, the ozone generating devices, which are presently utilized, are classified into three major categories of air discharging means, infrared means and water dissolving means. Those conventional means have disadvantages of heavy weight, bulky size, lower efficient and large power consumption in operation.

Especially, the air discharging means has disadvantage that it is very hard to dissolve the generated ozone into the water (H₂O). Furthermore, it is difficult to uniformly dissolve the ozone into the water. When the gaseous ozone is injected into water for dissolving, approximately 50% of the ozone would be bounced out to the air. Because the gaseous ozone is concentrated, it is harmful to the environment and human being.

Therefore, it is necessary to seek the more convenient and efficient means to dissolve the ozone uniformly and safely into the water. Therefore, a new concept of the underwater discharging means is developed to overcome the conventional problems.

### 3. DISCLOSURE OF INVENTION

Accordingly, in order to overcome the aforementioned conventional problems, the underwater discharging cells having the imaginary intersections “Virtual Meshed Points” are developed in the present invention. The purpose of the present invention is to provide an underwater discharging core that enables to maximize the sterilizing effect by maintaining the stabile production of ozone. The assembly process for producing the underwater discharging core is also simplified and easy.

The purpose of the present invention is to provide a sterilized water generator utilizing an underwater discharge core and a sterilized water supply system utilizing the sterilized water generator.

An objective of the present invention is to provide an underwater discharge core comprises: a frame having a rectangle opening, a first platinum plate mesh made of conductive material for mounting to said frame, an insulation plate meshes disposed over said first platinum plate meshes, a second platinum plate mesh made of conductive material overlapped the insulation plate meshes and first platinum plate meshes.

Another objective of the present invention is to provide a sterilized water generator utilizing an underwater discharge core comprises a container filled with water, an underwater discharging core consisted of a rectangular-shape frame, a first and second platinum plate meshes made of conductive material, an insulation plate made of non-conductive material installed on the frame, the container installed at least one underwater discharging core, and a power supply unit and control system for supplying power to the first and second platinum plate mesh cells to perform underwater discharge.

Another objective of the present invention is to provide a sterilized water supplying system comprises: a sterilized water generator utilizing at least one underwater discharge core unit equipped with an alternative power supply and control system for alternatively supplying power to a set of positive and negative terminals of platinum plate meshes, a water storage tank for storing the produced sterilized water, a filtration unit for filtering the foreign objects from the supplied water, and a power source/controlling unit for controlling the sterilized water generator.

Another objective of the present invention is to provide a sterilized water generator consisted of a rectangular-shape frame, a first and second platinum plate meshes made of conductive material, an insulation plate made of non-conductive material installed on the frame.

As discussed above, the underwater discharging core which utilizes the discharging cells with the imaginary wire meshes of “Virtual Meshed Points” to maximize the sterilizing effect and operating efficiency.

Therefore, it is possible to offer the excellent quality of sterilized water by adopting the sterilized water generator utilizing the underwater discharge core and a sterilized water supply system utilizing the sterilized water generator.

### 4. BRIEF DESCRIPTION OF DRAWINGS

The accompanying drawings, which are included to provide a further understanding of the invention, illustrate the preferred embodiments of the invention, and together with the description, serve to explain the principles of the present invention.

FIG. 1 is a schematic diagram of an underwater discharging core according to the first embodiment of the present invention.

FIG. 2 is a frame for installing the underwater discharging core according to the first embodiment of the present invention.

FIG. 3 is a first platinum plate meshes installed to the underwater discharging core according to the first embodiment of the present invention.

FIG. 4 is a schematic diagram of the first platinum plate meshes that is folded half at the center to form double layers.

FIG. 5 is a schematic diagram that the first platinum plate meshes is installed on the frame.

FIG. 6 is an insulation plate installed to the underwater discharging core according to the first embodiment of the present invention.

FIG. 7 is a schematic diagram of the insulation plate that is folded half at the center to form double layers.

FIG. 8 is a schematic diagram that the insulation plate is attached over the platinum plate meshes installed on the frame.

FIG. 9 is a second platinum plate meshes installed to the underwater discharging core according to the first embodiment of the present invention.

FIG. 10 is a schematic diagram of the second platinum plate meshes that is folded half at the center to form double layers.

FIG. 11 is an assembly diagram that the second platinum plate mesh is attached over the insulation plate and the first platinum plate meshes installed on the frame.

FIG. 12 is a final assembly of underwater discharging core according to the first embodiment of the present invention.

FIG. 13 illustrates a cross-sectional view at A-A of the final assembly of underwater discharging core.

FIG. 14 illustrates a cross-sectional view at B-B of the final assembly of underwater discharging core.

FIG. 15 illustrates a cross-sectional view at C-C of the final assembly of underwater discharging core.

FIG. 16 is the enlarged first and second platinum plate meshes for illustrating the operation of the underwater discharging core.

FIG. 17 is a schematic diagram for generating the sterilized water according to an implementing example of the present invention.

FIG. 18 is a schematic diagram of the sterilized water supplying system according to an implementing example of the present invention.

FIG. 19 is a schematic diagram of an underwater discharging core according to another embodiment of the present invention.

FIG. 20 is a frame for installing the underwater discharging core according to another embodiment of the present invention.

FIG. 21 is a first platinum plate mesh for installing to the underwater discharging core according to another embodiment of the present invention.

FIG. 22 is a schematic diagram illustrating the first platinum plate meshes installed on the frame according to another embodiment of the present invention.

FIG. 23 is a second platinum plate mesh for installing to the underwater discharging core according to another embodiment of the present invention.

FIG. 24 is a semi-assembly that the first and second platinum plate meshes are attached to the frame according to another embodiment of the present invention.

FIG. 25 is a schematic diagram of an underwater discharging core according to the third embodiment of the present invention.

FIG. 26 is a frame for installing the underwater discharging core according to the third embodiment of the present invention.

FIG. 27 is a first platinum plate meshes installed to the underwater discharging core according to the third embodiment of the present invention.

FIG. 28 is a schematic diagram illustrating the first platinum plate meshes installed on the frame according to the third embodiment of the present invention.

FIG. 29 is a second platinum plate meshes installed to the underwater discharging core according to the third embodiment of the present invention.

FIG. 30 is a semi-assembly that the second platinum plate mesh is attached over the first platinum plate meshes installed on the frame according to the third embodiment of the present invention.

Features, elements, and aspects of the invention that are referenced by the same numerals in different figures represent the same, equivalent, or similar features, elements, or aspects in accordance with one or more embodiments.

### 5. MODES FOR CARRYING OUT THE INVENTION

In order to accomplish the aforementioned objectives, an underwater discharging core and its application to the system for generating and supplying the sterilized water according to the present invention is described in detail accompany with the drawings.

The underwater discharging core of the present invention is designed to generate massive ions by inducing the underwater discharging even though the applied voltage is low. In order to generate the ions at the low voltages, the water breakdown mechanism or underwater discharging mechanism must be utilized. The principle of underwater discharge which is known as a bubble mechanism is as follows: when a cathode is applied the voltage, the impurities dissolved in the water initiates the electrolytic dissociation to form a Nucleation Site at the asperities of the cathode by collecting OH⁻ ion. It causes to form an electric field region and induce the local heating to evaporate the water molecules by forming the water bubbles. When the water bubbles start to generate, it propagates rapidly from cathode to anode to form a Conduction Filamentation Channel between the two electrodes. This phenomenon is the bubble mechanism due to the underwater discharge. At this point, the sharper tips of the cathode and anode, the more discharge at the low voltage. The amount of the active oxygen generated by the underwater discharging is proportion to the number of the Point Electrodes or discharging cells.

The present invention is based on the new concept that a discharge core submerged in the dielectric material of water is operated, and distinguished from the conventional system using the etching platinum plate.

Namely, if it is assumed that the switches supplied power from the power supply unit is submerged in the water container, the water itself could be a switching medium and the platinum could be composed of the cathode and anode. Herein, the switches that are the underwater discharge cells perform self-switching or water breakdown through the water breakdown mechanism when a certain level of voltage is applied. Once the underwater discharge cell is switched on, a Conduction Filamentation Channel is formed between the cathode and anode. When the voltage of the underwater discharge cell becomes zero, the path between the cathode and anode is filled with water. Then, the voltage is resumed between the cathode and anode by self-recovery. These processes of self-switching and self-recovery are sequentially repeated to effectively produce the ions.

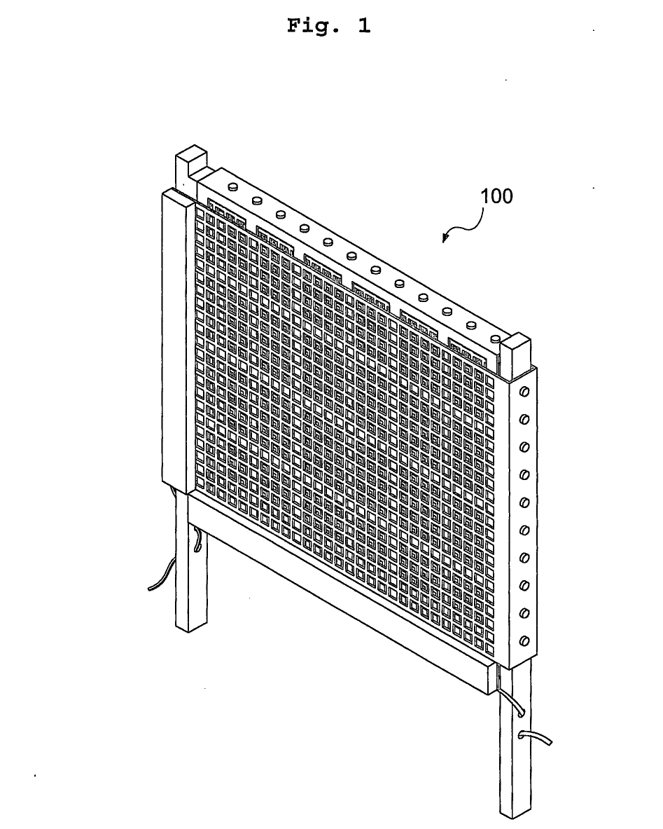

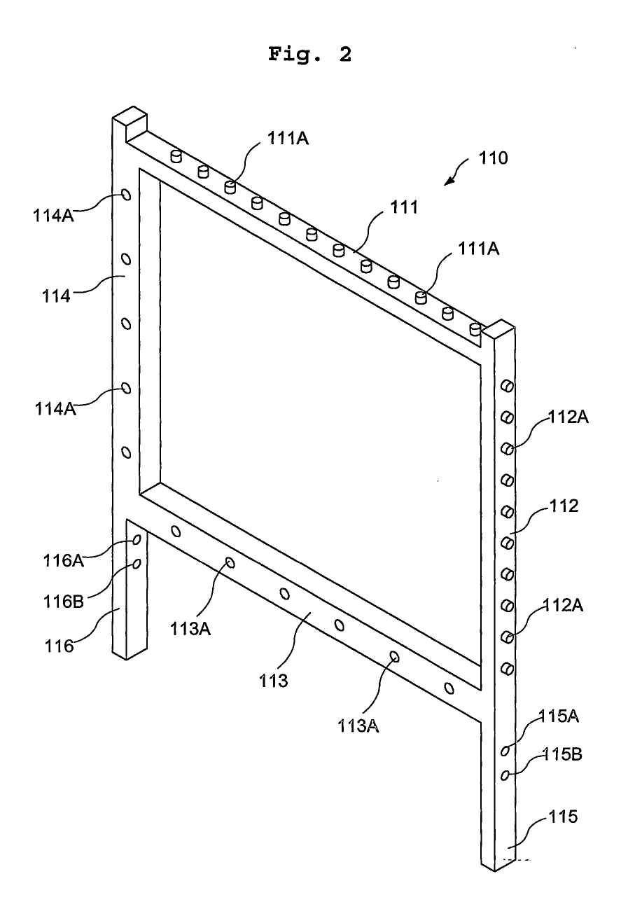

As shown in FIG. 1, an underwater discharging core (100) is presented according to the first embodiment of the present invention. Further, FIGS. 2 through 16, the configuration and assembly of the underwater discharging core (100) are illustrated.

As shown in FIG. 2, a frame for installing the underwater discharging core is presented according to the first embodiment of the present invention. The frame (110) made of polycarbonate forms a rectangle shape with the two supporting legs. The frame (110) comprises an upper bar (111), a lower bar (113), a right bar (112) and a left bar (114). On top surface of the upper bar (111), it forms a plurality of protrusions (111A). The first surface of the lower bar (113), it forms a plurality of drilled holes (113A). The second surface of the right bar (112), it forms a plurality of protrusions (112A). The first surface of the left bar (114), it forms a plurality of drilled holes (114A). The right supporting leg (115) is integrally extended from the right bar (112) formed with a pair of drilled holes (115A, 115B). The left supporting leg (116) is integrally extended from the left bar (114) formed with a pair of drilled holes (116A, 116B).

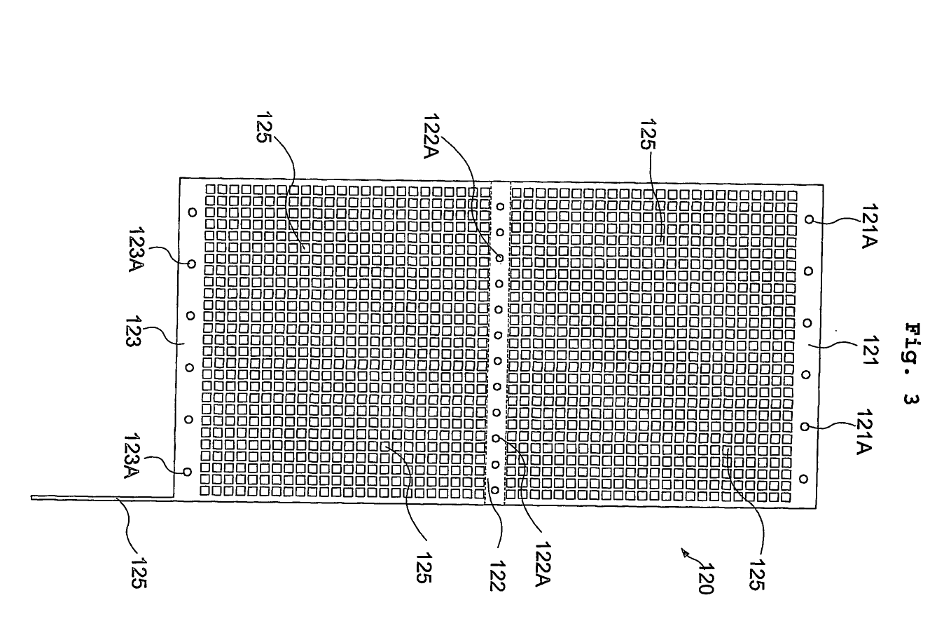

As shown in FIG. 3, a first platinum plate meshes is presented for installing to the underwater discharging core according to the first embodiment of the present invention.

As seen in the figure, a center section (122) of the first platinum plate meshes (120) has the same number of holes (122A) to mate with the protrusions (111A) of the upper bar (111) of the frame (110). Both end sections (121, 123) of the first platinum plate meshes (120) forms the same number of drilled holes (121A, 123A) to mate with the drilled holes (113A) of the lower bar (113) of the frame (110). An extended wire (124) is formed at the end of one end section (123) for the electrical connection. The first platinum plate (120) has a plurality of tiny square cutouts (125) between both end sections (121, 123) and center section (122) to form the meshes.

It is preferable to use platinum group for the first platinum plate (120) because it is easy to form through die-forging process. The first platinum plate (120) has the dimensions of 0.1 mm-2 mm thickness, 0.1×0.1 mm-2×2 mm clearance for the tiny square cutouts (125), 0.1 mm˜2 mm width for the extended wire (124). It is also possible to use Iridium, which is the platinum group for first platinum plate (120).

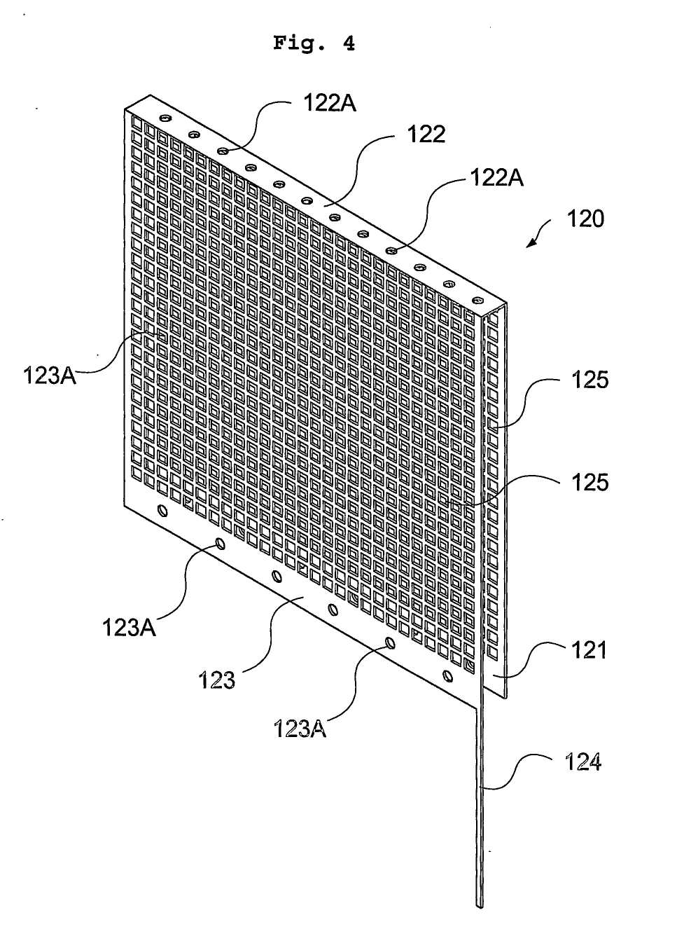

Then, the first platinum plate (120) is folded along the dot lines on the center section (122) to form a bent shape as seen in FIG. 4. The first clearance of the folded first platinum plate (120) is same as the upper bar (111) thickness of the frame (110).

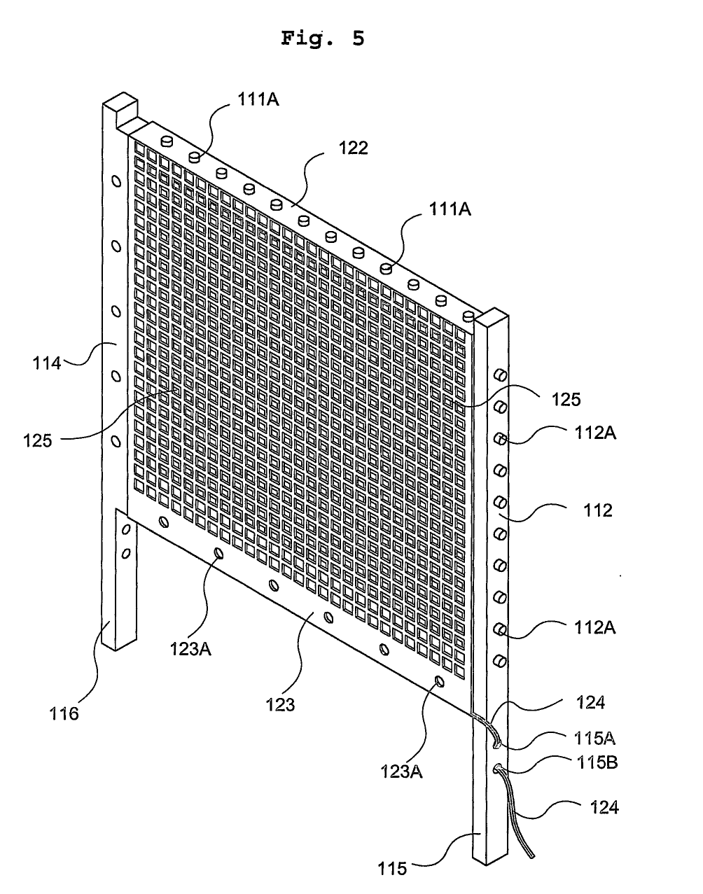

The plurality of drilled holes (122A) provided at the center section of the first platinum plate (120) is mated with the protrusions (111A) of the upper bar (111) of the frame (110). The extended wire (124) is installed through the holes (115A, 115B) of the supporting leg (115) as shown in FIG. 5.

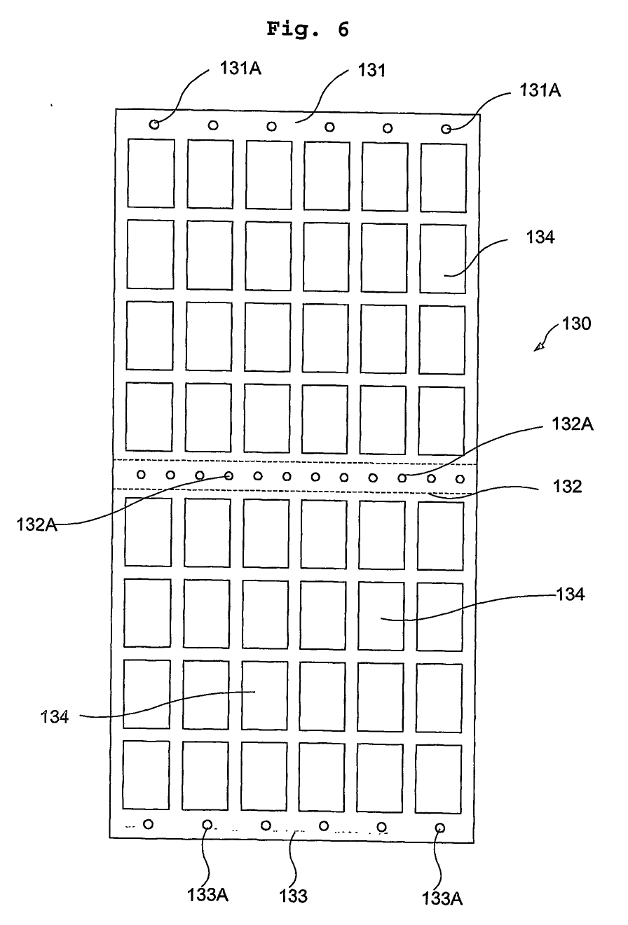

As seen in FIG. 6, an insulation plate is presented for installing to the underwater discharging core. The insulation plate (130) forms a plurality of drilled holes (132A) at the center section (132) to mate with the protrusions (111A) of the upper bar (111) of the frame (110). Both end sections (131, 133) of the insulation plate (130) forms the same number of drilled holes (131A, 133A) to mate with the drilled holes (113A) of the lower bar (113) of the frame (110). The insulation plate (130) is also provided a plurality of rectangular cutouts (134) between both end sections (131, 1323) and center section (132) to form the openings.

The insulation plate (130) is preferably made of the heat-resistance plastic material such as a polycarbonate with 0.5 mm˜3 mm thickness.

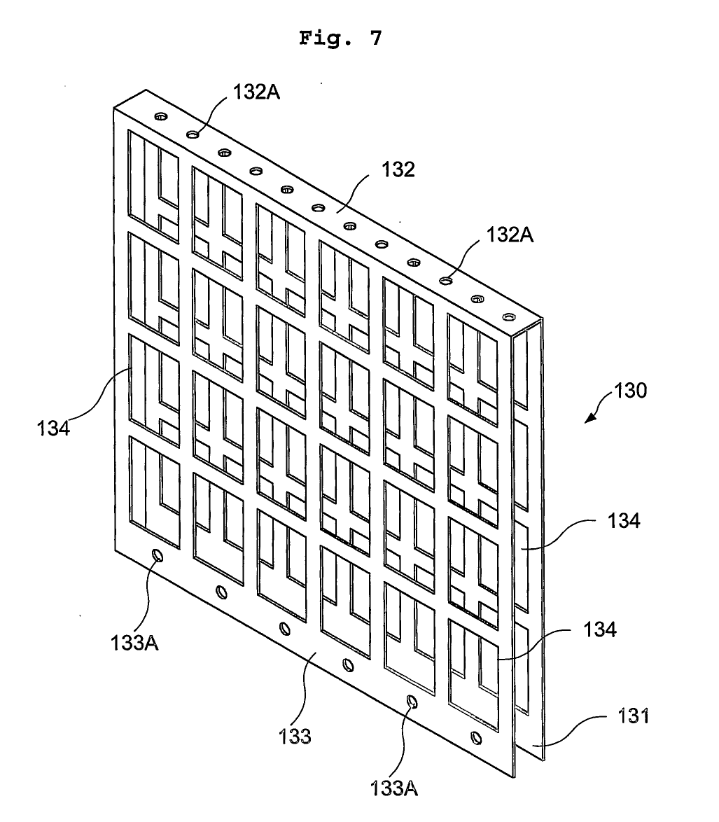

Then, the insulation plate (130) is folded along the dot lines on the center section (132) to form a folded shape as seen in FIG. 7. Herein, the first clearance of the folded insulation plate (130) is same as second clearance of the folded first platinum plate (120) including the upper bar (111) thickness of the frame (110).

As seen in FIG. 7, a plurality of drilled holes (132A) is also provided at the top center section (132) of the folded insulation plate (130) to mate with the protrusions (111A) of the upper bar (111) of the frame (110) overlapped with the folded first platinum plate (120). Both end sections (131, 133) of the insulation plate (130) formed with the same number of drilled holes (131A, 133A) are matched with the drilled holes (113A) of the lower bar (113) of the frame (110) and the drilled holes (121A, 123A) of both end sections (121, 123) of the folded first platinum plate meshes (120).

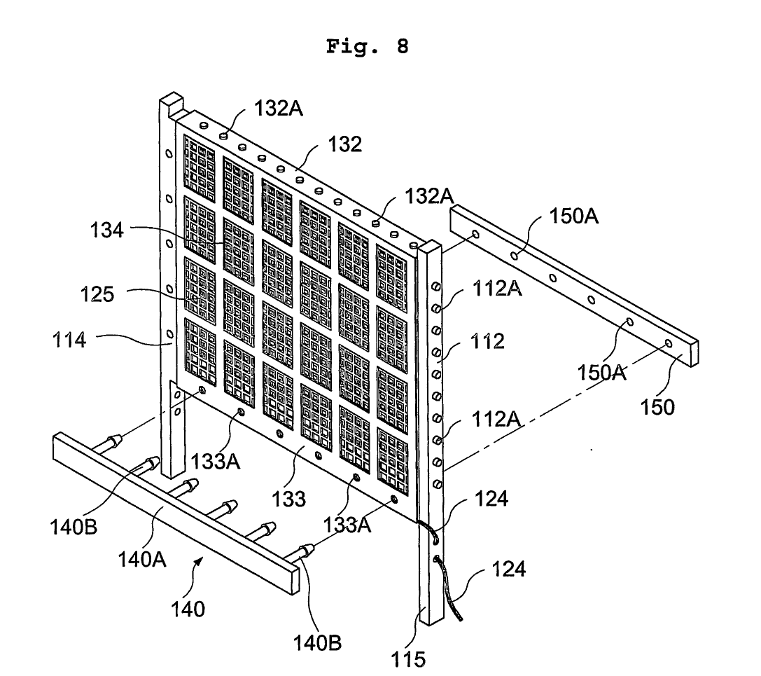

As seen in FIG. 8, a plurality of pins (140B) on the retainer (140) is installed through the drilled holes (133A, 123A, 113a, 121A, 131A) to match with the holes (150A) of the retainer clip (150). Through the aforementioned process, the frame (110), the folded first platinum plate (120) and the folded insulation plate (130) are assembled together.

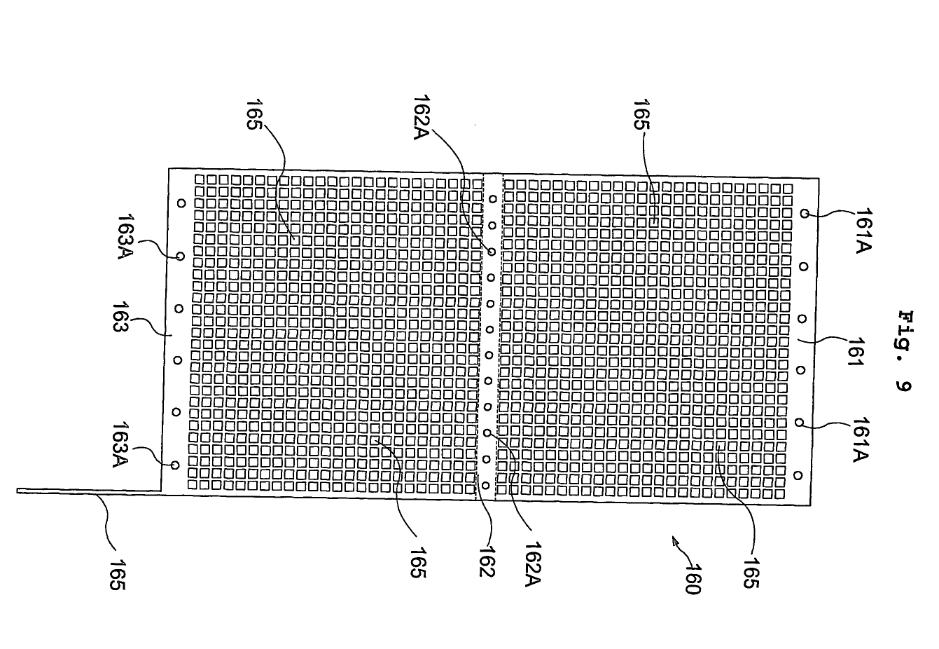

As shown in FIG. 9, a second platinum plate meshes is presented for installing to the underwater discharging core according to the first embodiment of the present invention.

As seen in the figure, a center section (162) of the second platinum plate meshes (160) has the same number of holes (162A) to mate with the protrusions (112A) of the right bar (112) of the frame (110). Both end sections (161, 163) of the second platinum plate meshes (160) forms the same number of drilled holes (161A, 163A) to mate with the drilled holes (114A) of the left bar (114) of the frame (110). An extended wire (164) is formed at the end of one end section (163) for the electrical connection. The second platinum plate (160) has a plurality of tiny square cutouts (165) between both end sections (161, 163) and center section (162) to form the meshes.

Same as the first platinum plat, it is preferable to use platinum group for the second platinum plate (160) because it is easy to form through die-forging process. The second platinum plate (160) has the dimensions of 0.1 mm˜2 mm thickness, 0.1×0.1 mm˜2×2 mm clearance for the tiny square cutouts (165), 0.1 mm˜2 mm width for the extended wire (164). It is also possible to use Iridium, which is the platinum group for first platinum plate (160).

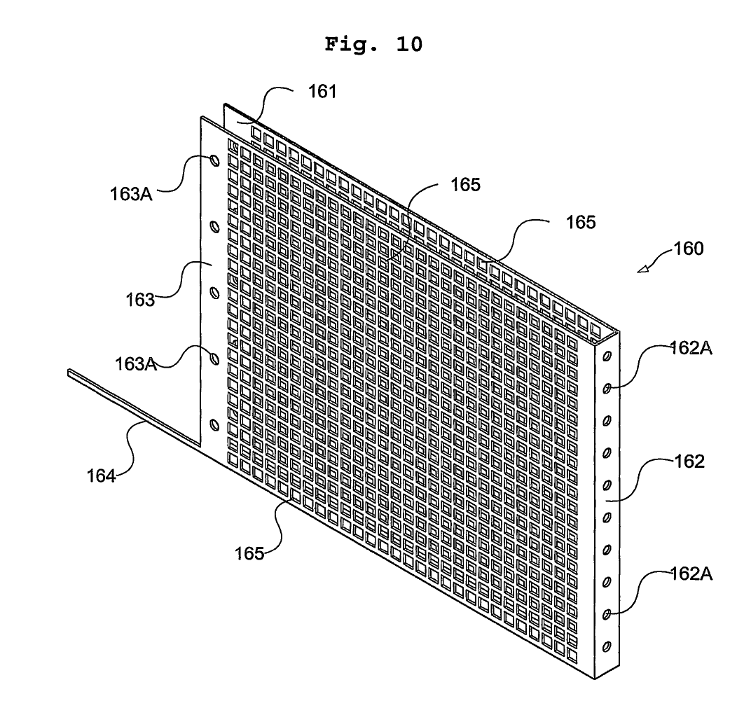

Then, the second platinum plate (160) is folded along the dot lines on the center section (162) to form a bent shape as seen in FIG. 10. The first clearance of the folded second platinum plate (160) is same as the right bar (112) thickness of the frame (110).

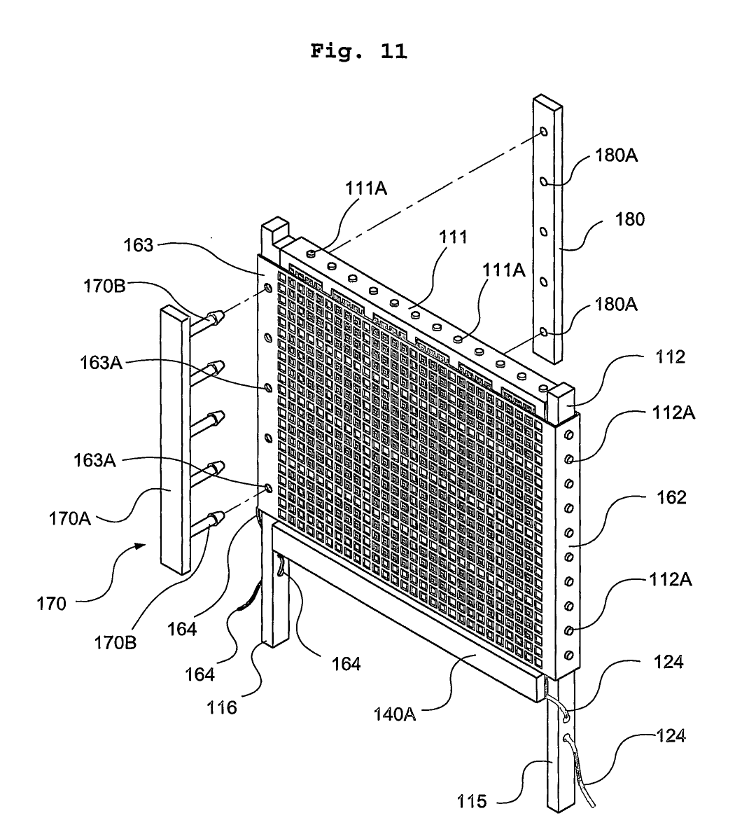

The plurality of drilled holes (162A) provided at the lateral center section of the folded second platinum plate (160) is mated with the protrusions (112A) of the right bar (112) of the frame (110). The extended wire (164) is installed through the holes (116A, 116B) of the supporting leg (116) as shown in FIG. 11. Further, a plurality of drilled holes (161A, 163A) is also provided at both end section (161, 163) of the folded second platinum plate (160) to mate with the drilled holes (114A) of the left bar (114) of the frame (110).

As seen in FIG. 11, a plurality of pins (170B) on the retainer (170) is installed through the drilled holes (163A, 114A, 161A) to match with the holes (180A) of the retainer clip (180). Through the above process, the folded second platinum plate (160) is assembled to the frame (110).

It is also possible to use the plated platinum meshes or plated Iridium meshes instead of the solid platinum or Iridium plate meshes.

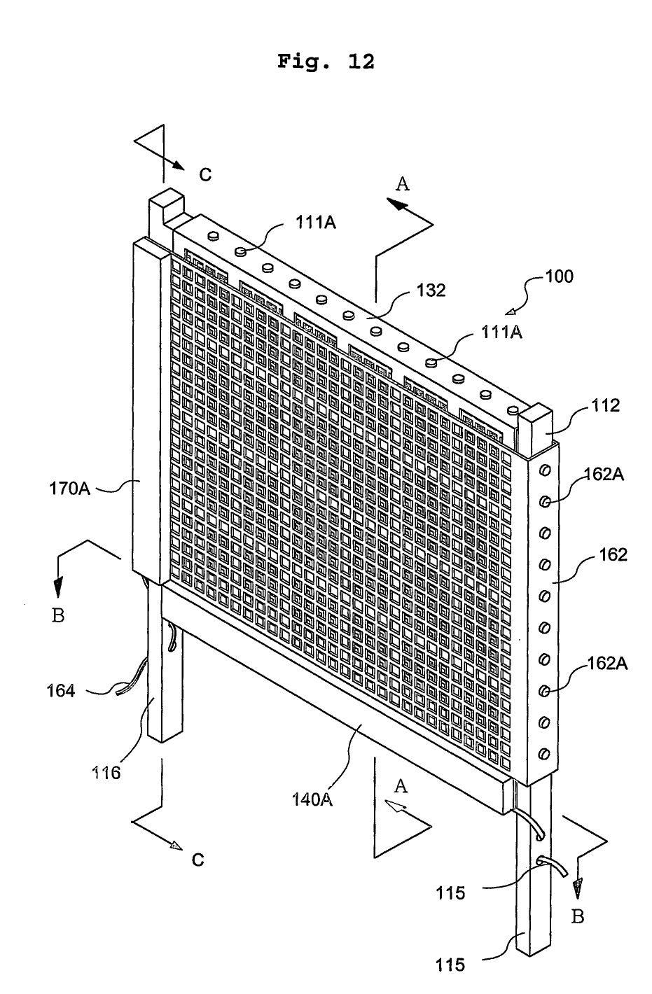

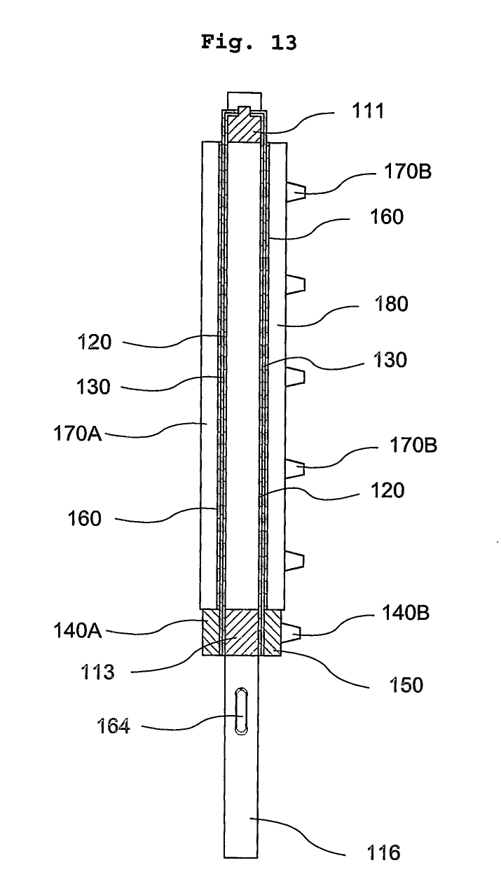

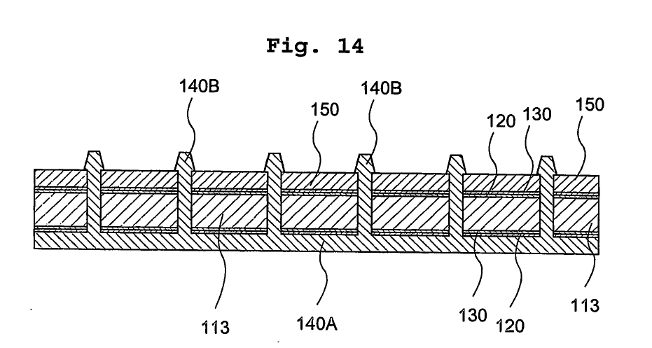

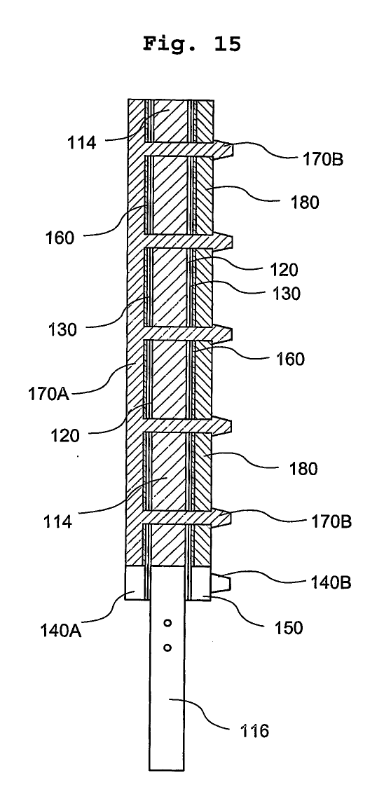

As seen in FIG. 12, a final assembly of the underwater discharging core is presented according to the first embodiment of the present invention. A cross-sectional view at A-A of the final assembly of underwater discharging core is illustrated in FIG. 13. Another cross-sectional view at B-B of the final assembly of underwater discharging core is illustrated in FIG. 14. A cross-sectional view at C-C of the final assembly of underwater discharging core is illustrated in FIG. 15.

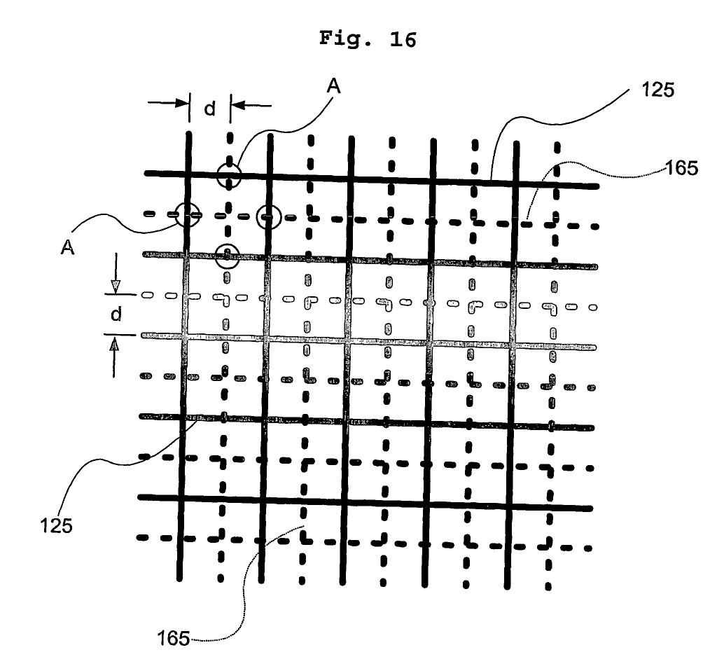

As seen in FIG. 16, each first platinum plate meshes (120) and second platinum plate meshes (160) forms a plurality of minute square cutouts (125, 165) with preferably square 2d (diameter) in dimension. The insulation plate (130) is disposed between the first platinum plate meshes (120) and the second platinum plate meshes (160). The first platinum plate meshes (120) is arranged with the second platinum plate meshes (160) to misalign the openings of minute square cutouts (125, 165). Therefore, it is preferable that the projected openings of the overlapped first platinum plate meshes (120) and second platinum plate meshes (160) have square one d (diameter) in dimension as seen the solid and dotted lines in the figure.

The first platinum plate meshes (120) and the second platinum plate meshes (160) are maintained a certain constant clearance each other to form a plurality of the projected intersections of the Virtual Meshed Points “A” for performing the underwater discharge. (For example, the clearance is same as the thickness of insulation plate or approximately 1 mm.)

Due to the adoption of the first and second platinum plate meshes of the present invention, it is possible to perform the full or semi-automatic controls in the underwater discharge system unlike the conventional system used for winding the platinum wires.

Further, the platinum plate meshes of the present invention are able to operate stably discharge due to the uniform first and second platinum plate meshes. If the platinum wire were not uniformly wound in the conventional winding, it would be troublesome in the operation due to the different wire tensions. Thus, it is required the experienced winding skill for winding the platinum wires in the conventional platinum wires.

Because the platinum plate meshes of the present invention is able to produce through the die forging and assembly process, it has advantages to increase efficiency and mass production and reduce the production cost compared with the conventional process.

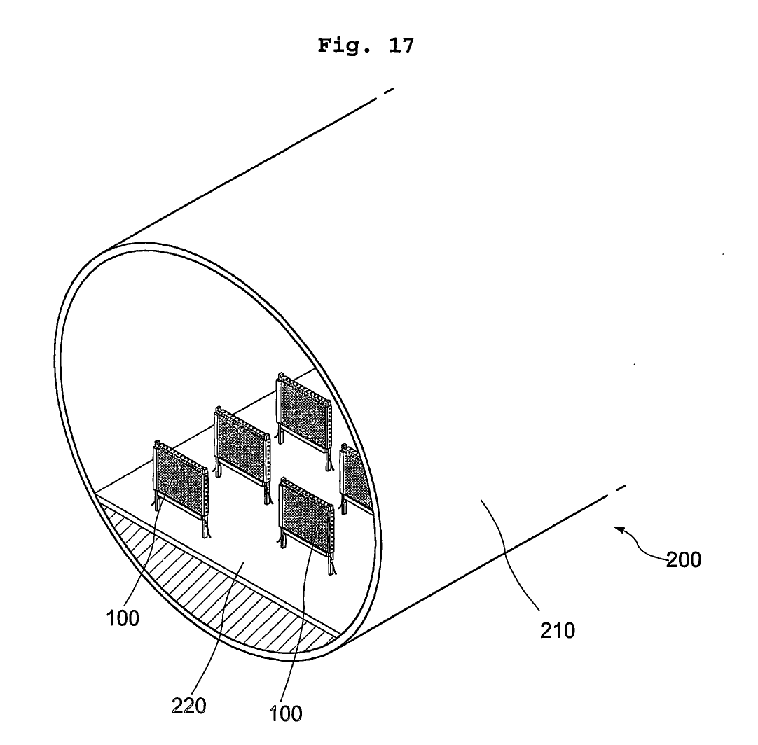

As seen in FIG. 17, a schematic diagram for generating the sterilized water is presented according to an implementing example of the present invention. The sterilized water generator (200) is comprised of a container (210), a base plate (220), an underwater discharging core (100), power supply unit and control system.

The container (210) filled with water is installed to flow the water vertically or a certain angle (for example 45°). The base plate (220) is installed at lower bottom section of the container (210) and one side of base plate (220) is treated with the waterproof. The underwater discharge core (100) is vertically installed on the base plate (220). The number of underwater discharge core (100) is determined depending on the capacity of the sterilized water generator (200). When more than one underwater discharging core (100) is installed in the container (210), it may be arranged in serial or zigzag. Each extended wire (124, 164) of the first and second platinum plate meshes is connected to the DC power supply source and control systems through underneath the base plate (220). The space underneath the base plate (220) is sealed for waterproof.

The container (210) could be a water storage tank or water supply pipeline. Inside of the container, a thermal sensor is installed for detecting the water temperature to prevent overheating. If the sensor detects a certain level of higher abnormal temperature than the normal operating temperature, it actuates the automatic control system to cut off the power supply to the underwater discharging core (100).

If it were necessary to increase the capacity of sterilized water generator (200), the number of underwater discharge core units (100) in the container would be increased. At this point, it is possible to arrange the underwater discharge core units (100) not only on the floor in serial, but also overhead symmetrically. Therefore, the capacity of sterilized water generator (200) can be increased without increasing the volume of the underwater discharge core (100).

When a power source is connected to the first and second platinum plate meshes of the underwater discharge core (100), the positive voltage is fixedly supplied to one terminal and the negative voltage fixedly supplied to the other terminal. The general method of connection makes the ionized impurities built up on the positive voltage terminal. Due to the deposit of impurities, it curses to remarkably deteriorate the efficiency of the underwater discharge core (100).

In order to solve the aforementioned problems, the underwater discharge unit (100) of the present invention adopts the power supply and control system that is alternative supplied the positive voltage (+V) to one terminal and the negative voltage (−V) to the other terminal with 0.5˜5 minute intervals. Due to the alternative power supplies to the first and second platinum plate meshes, it is possible to prevent the built-up impurities on the meshed points of the positive voltage (+). Thus, it is also possible to prevent the efficiency deterioration of the underwater discharge core units (100).

Through the above mechanism, a Nucleation Site is formed by the ionized impurities and the electrolytic dissociated ions at the projected intersections of the Meshed Points “A” of the first and second platinum plate meshes. Around the Nucleation Site, a localized electric field region is enhanced to form a high density of local current that causes to heat locally and evaporate the water molecules by forming the water bubbles. Once the water bubbles are generated, the water bubbles are rapidly propagated to form a Conduction Filamentation Channel between the cathode (+) and anode (−). This is the bubble mechanism due to the underwater discharge.

When the discharge is occurred under the water, the water molecules are dissociated. The chemical reaction is as follows:
H₂O+E→H, O
O+O→O₂
H→H⁺
O₂→O₂⁻
H⁺, O₂+H₂O→H₂O₂ (Evaporation), OH (Dissolved in the water)

Wherein, E is an electrical energy, which is applied to H₂O in the Electric Field.

The produced negative ions (OH—, O—) and the small amount of Ozone (O₃) are oxidized with the heavy metals and ionized impurities dissolved in the water to activate the impurities and sterilize the microbe such as a virus and bacteria in the water by displacing the hydrogen of the microbial cells.

The treatment of the active oxygen produced by the underwater discharge core (100) is different depending on the usages of the ionized water. For the purpose of sterilize the germs in the water, the active oxygen produced by the underwater discharge core (100) is directly used. Due to the ions (OH—, O—) and the small amount of Ozone (O₃) dissolved in the ionized water, it is possible to kill the germs and neutralize the heavy metals or harmful chemicals, which might be contaminated in the vegetables, fruits or utensils.

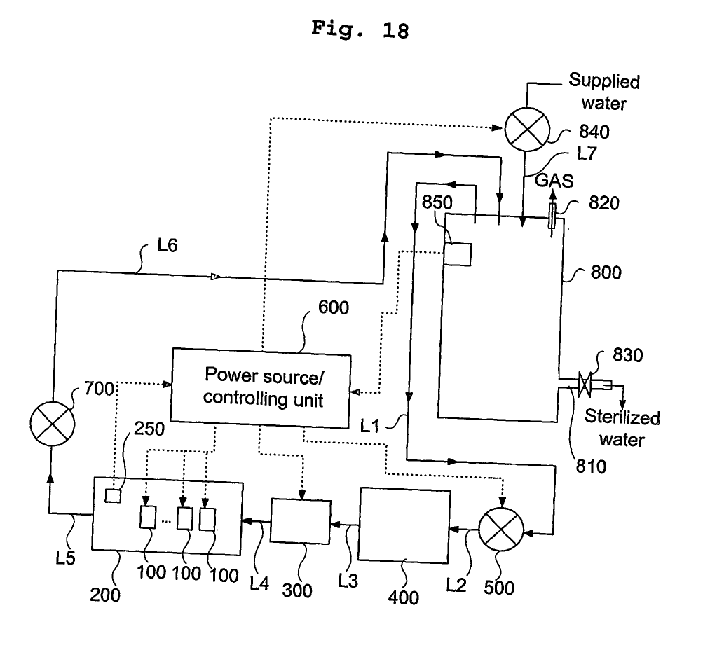

Referring to FIG. 18, a schematic diagram of the sterilized water supplying system is presented according to an implementing example of the present invention. The sterilized water supplying system comprises a sterilized water generator (200) installed at least one underwater discharge core (100), a water storage tank (800) for storing the produced sterilized water, a filtration unit (400) for filtering the foreign objects from the supplied water and a power source/controlling unit (600).

A water pump (300) is installed between the filtration unit (400) and the sterilized water generator (200) for supplying the water from the water storage tank (800) through the water pipelines (L1, L2, L3, L4). A solenoid vale (500) disposed between the water storage tank (800) and the filtration unit (400) is connected to the power source/controlling unit (600) for controlling the water supply. A check valve (700) is installed between the sterilized water generator (200) and the water storage tank (800) through the water pipelines (L5, L6) to allow the water flow one direction.

A thermal sensor (250) is installed inside the sterilized water generator (200) for sensing the operating water temperature to prevent overheating the system. The controlling unit (600) is activated the motor pump (300) and the solenoid vale (500) according to the detected temperature by the thermal sensor (250).

Another solenoid vale (840) installed on the water supply pipeline (L7) is connected to the controlling unit (600) for controlling the water supply. A sensor (850) for sensing the water level is installed inside of the water storage tank (800). The solenoid vale (840) is actuated by the controlling unit (600) based on the detected signal from the water level sensor (850).

Herein, a closed circulation of the water sterilizing system is configured that the fresh water is supplied from outside water source through the solenoid vale (840) controlled by the controlling unit (600) based on the sensed signal of water level sensor (850). Once the storage water is filled, the water in the tank (800) is supplied to the sterilized water generator (200) by the motor pump (300) and controlled by the controlling unit (600) through the water pipeline (L1), solenoid vale (500), water pipeline (L2), the filtration unit (400), water pipeline (L3), the water pump (300)), water pipeline (L4) and the sterilized water generator (200). After the water is treated through the sterilized water generator (200), the sterilized water is returned back to the water storage tank (800) through the water pipeline (L5), a check valve (700) and the water pipeline (L6). Then, the water is circulated until the water in the tank (800) is completely treated.

On the other hand, a continuous water supply system is configured that the fresh water supply from outside water source is directly connected to the filtration unit (400) through the solenoid vale (840). In this system, the solenoid vale (840) for supplying the fresh water is also controlled by the controlling unit (600) based on the sensed signal of water level sensor (850). Excluding the inlet connection of the water supply and the solenoid vale (500) located between the water storage tank (800) and filtration unit (400), the rest of the system is same as the closed circulation system. The water in the tank (800) is circulated to the sterilized water generator (200) by the motor pump (300) and controlled by the controlling unit (600) through the water pipeline (L1, L2), the filtration unit (400), water pipeline (L3), the water pump (300), water pipeline (L4) and the sterilized water generator (200). The circulated water is treated through the sterilized water generator (200), and returned back to the water storage tank (800) through the water pipeline (L5), a check valve (700) and the water pipeline (L6). At this point, it is preferable to set the circulating period with a certain intervals.

The water storage tank (800) is also equipped with a vent (820) for discharging the gases and outlet valve (830) connected to the outlet pipeline (810). The power supply is connected to the underwater discharge core (100) in the manner of alternative supply of positive voltage (+V) to one terminal and the negative voltage (−V) to the other terminal with 0.5-5 minute intervals.

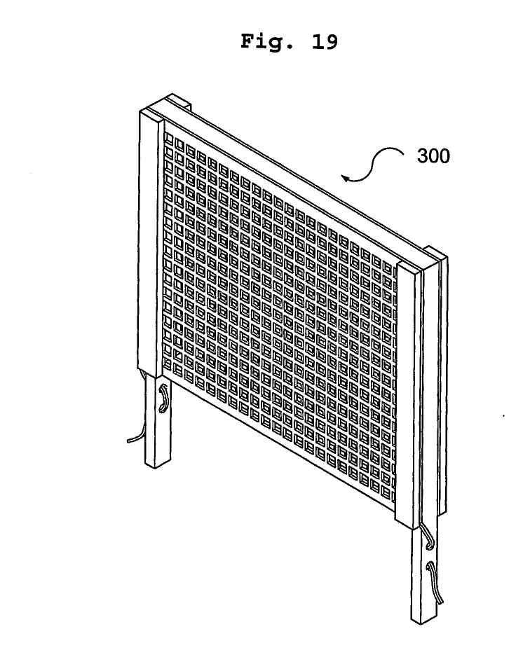

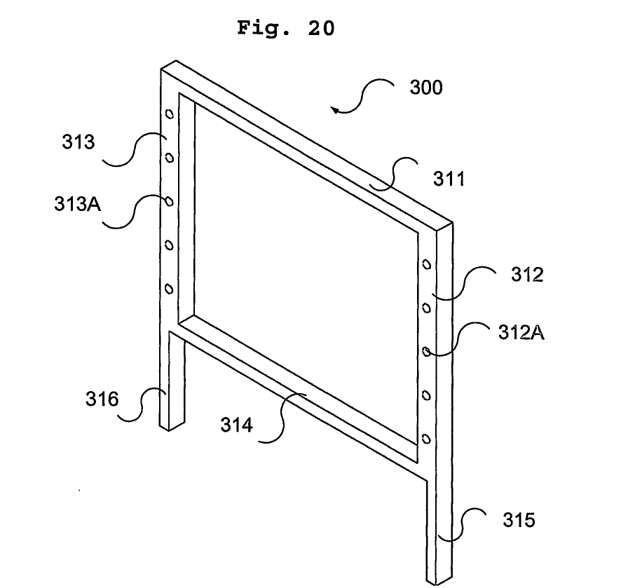

As shown in FIG. 19, an alternative underwater discharging core (300) is presented according to the second embodiment of the present invention. Herein, FIGS. 20 through 24, the configuration and assembly of the alternative underwater discharge core are illustrated.

As shown in FIG. 20, a frame for installing the alternative underwater discharging core is presented according to the second embodiment of the present invention. The frame (310) made of the heat resistance material, such as a polycarbonate forms a rectangle shape with the two supporting legs. The frame (310) comprises an upper bar (311), a lower bar (314), a right bar (312) and a left bar (313). The first surface of the right and left bars (312, 313), it forms a plurality of drilled holes (312A, 313A). The right supporting leg (315) is integrally extended from the right bar (312). The left supporting leg (316) is integrally extended from the left bar (313).

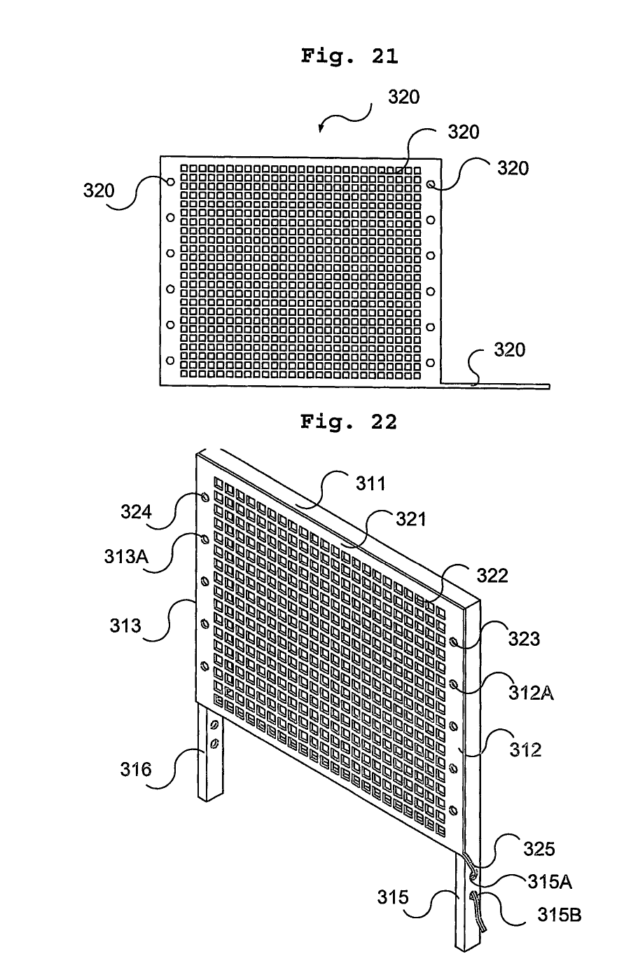

As shown in FIG. 21, a first platinum plate mesh is presented for installing to the underwater discharging core according to the second embodiment of the present invention.

As seen in the figure, both right and left end sections of the first platinum plate mesh (320) forms the same number of drilled holes (323, 324) to mate with the drilled holes (312A, 313A) of the left and right bars (312, 313) of the frame (310). An extended wire (325) is formed at the corner of the end section for the electrical connection. The first platinum plate (320) has a plurality of tiny square cutouts (322) in the mid section to form the mesh.

It is preferable to use platinum group for the first platinum plate (320) because it is easy to form through die-forging process. The first platinum plate (320) has the dimensions of 0.1 mm-2 mm thickness, 0.1×0.1 mm˜2×2 mm clearance for the tiny square cutouts (322), 0.1 mm˜2 mm width for the extended wire (325). It is also possible to use Iridium, which is the platinum group for the first platinum plate (320).

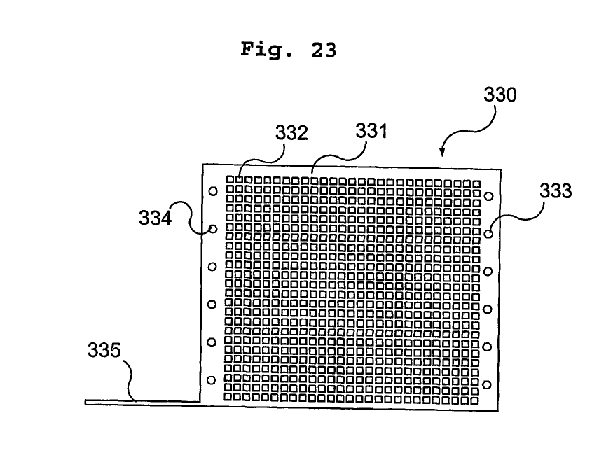

As seen in FIG. 22, the first platinum plate (320) is directly attached to the frame (310). Therefore, the drilled holes (323, 324) located on both end sections of the first platinum plate (320) are matched with the drilled holes (312A, 313A) of the right and left bars (312, 313) of the frame (310). The extended wire (325) is installed through the holes (315A, 315B) of the supporting leg (315).

As shown in FIG. 23, a second platinum plate mesh is presented for installing to the underwater discharging core according to another embodiment of the present invention.

As seen in the figure, both right and left end sections of the second platinum plate mesh (330) forms the same number of drilled holes (333, 334) to mate with the drilled holes (312A, 313A) of the left and right bars (312, 313) of the frame (310). The second platinum plate (330) has a plurality of tiny square cutouts (332) in the mid section (331) to form the mesh. An extended wire (335) is formed at the corner of the end section for the electrical connection.

It is preferable to use platinum group for the second platinum plate (330) because it is easy to form through die-forging process. The second platinum plate (330) has the dimensions of 0.1 mm˜2 mm thickness, 0.1×0.1 mm˜2×2 mm clearance for the tiny square cutouts (332), 0.1 mm˜2 mm width for the extended wire (335). It is also possible to use Iridium, which is the platinum group for the second platinum plate (330).

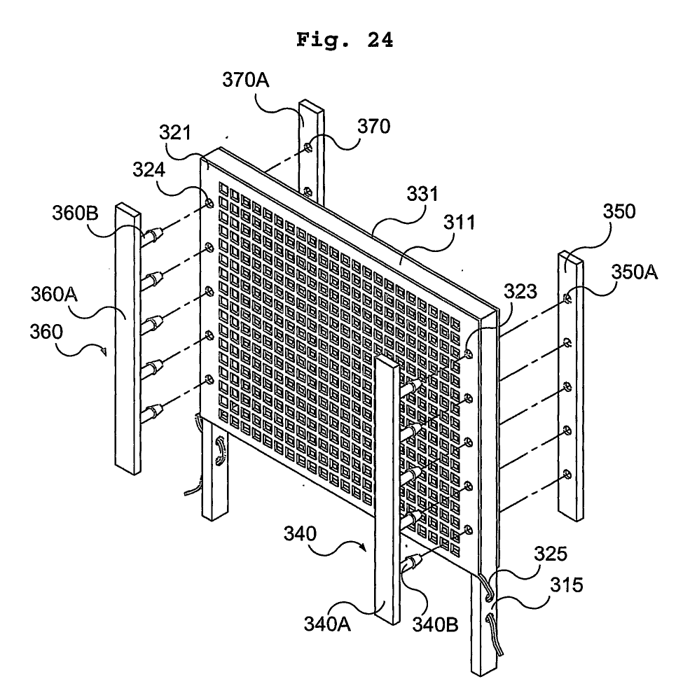

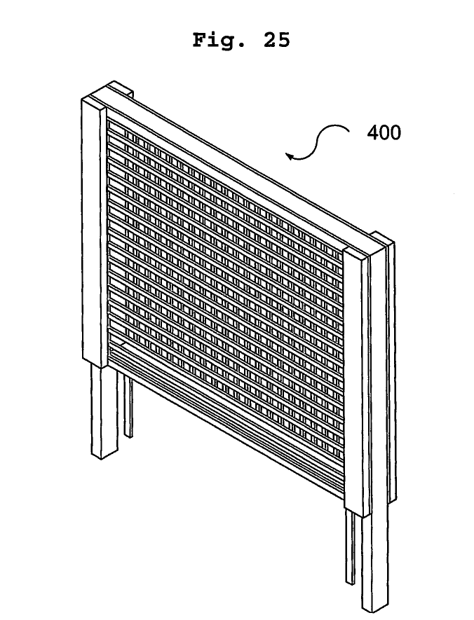

As seen in FIG. 24, the second platinum plate (330) is also directly attached to the frame (310). Therefore, the drilled holes (333, 334) located on both end sections of the second platinum plate (330) are matched with the drilled holes (312A, 313A) of the right and left bars (312, 313) of the frame (310). The extended wire (335) is installed through the holes (316A, 316B) of the supporting leg (316).

Referring to FIG. 24, a semi-assembly of the first and second platinum plate meshes is illustrated that the first and second platinum plate meshes are directly attached on the first and second surfaces of the frame (310) in the manner that the drilled holes (323, 324) of the first platinum plate (320) and the drilled holes (333, 334) of the second platinum plate (330) are matched with the drilled holes (312A, 313A) of the right and left bars (312, 313) of the frame (310). As the drilled holes are matched one another, a pair of retainers (340, 360) having a plurality of pins (240B, 360B) is installed through the drilled holes (323, 324, 312A, 313A, 333, 334) to lock into the holes (350A, 370A) of the retainer clips (350, 370).

The first and second platinum plate meshes (320, 330) of the underwater discharge core (300) forms a plurality of tiny square cutouts (322, 332) with preferable dimension of square 2d (diameter).

The first platinum plate mesh (320) is arranged with the second platinum plate mesh (330) to misalign the openings of tiny square cutouts (322, 332). Thus, it is preferable that the projected openings of the overlapped first platinum plate mesh (320) and second platinum plate mesh (330) have dimension of square one d (diameter) as seen the solid and dotted lines in FIG. 16.

The first and second platinum plate meshes (320, 330) are maintained a certain constant clearance each other and formed a plurality of projected intersections of the Virtual Meshed Points “A” for performing the underwater discharge. The first and second platinum plate meshes are also possible to use the plated platinum meshes or plated Iridium meshes instead of the solid platinum or Iridium plate meshes.

Referring to FIGS. 25 to 30, another alternative underwater discharging core (430) is presented according to the third embodiment of the present invention. The configuration and assembly of the third alternative underwater discharge core are illustrated as follows.

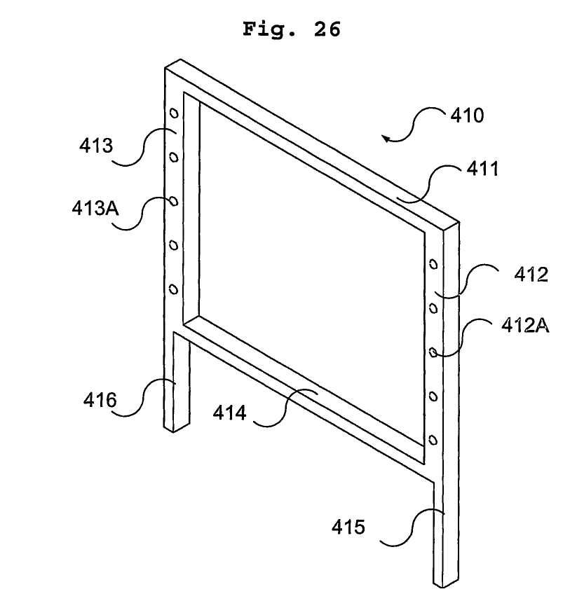

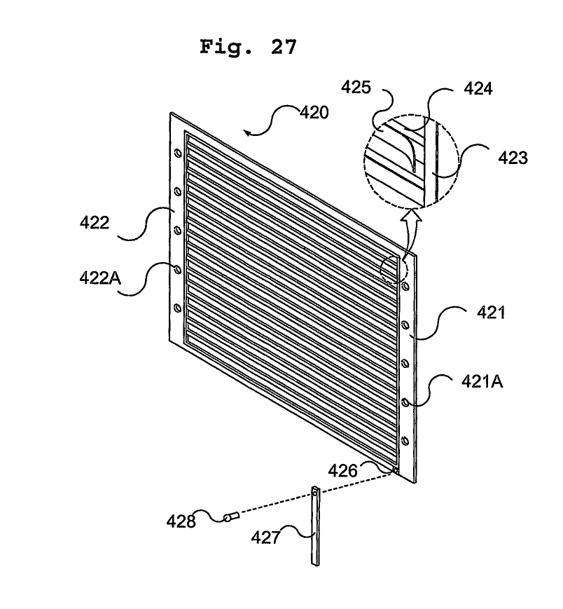

As shown in FIG. 26, a frame for installing the third alternative underwater discharge core is presented according to the third embodiment of the present invention. The frame (410) made of the heat resistance material, such as a polycarbonate forms a rectangle shape with the two supporting legs. The frame (410) comprises an upper bar (411), a lower bar (414), a right bar (412) and a left bar (413). The first surface of the right and left bars (412, 413), it forms a plurality of drilled holes (412A, 413A). The right supporting leg (415) is integrally extended from the right bar (412). The left supporting leg (416) is integrally extended from the left bar (413).

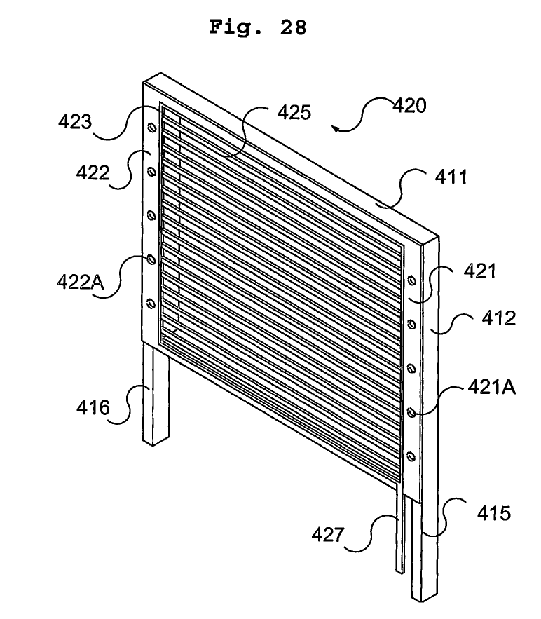

As shown in FIG. 27, a first platinum plated mesh is presented for installing to the underwater discharging core according to the third embodiment of the present invention. As seen in the figure, both right and left edge sections (421, 422) of the first platinum plated mesh (420) forms the same number of drilled holes (421A, 422A) to mate with the drilled holes (412A, 413A) of the left and right bars (412, 413) of the frame (410).

The first platinum plated mesh (420) could be used either a conductive material, such as Titanium or heat resistance material, such as a polycarbonate. The first platinum plated mesh (420) comprises a platinum plated edges (423) at both right and left ends, a plurality of strip bars (424) and strip liners (425) disposed along the x-axis.

At the corner of the platinum plated edges (423), an electrode pad (426) is provided for attaching an electrode bar (427).

As seen in FIG. 28, the first platinum plated mesh (420) is directly mounted on the frame (410). The drilled holes (421A, 422A) of right and left edge sections (421, 422) of the first platinum plated mesh (420) are mated with the drilled holes (412A, 413A) of the left and right bars (412, 413) of the frame (410). It is also possible to use Iridium plated mesh, which is the platinum group for the first platinum plated mesh (420).

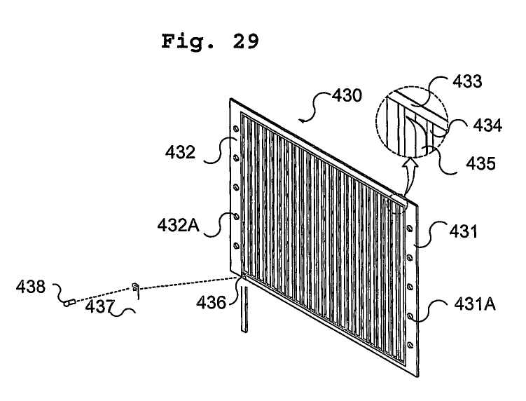

As shown in FIG. 29, a second platinum plated mesh is presented for installing to the underwater discharging core according to the third embodiment of the present invention. As seen in the figure, both right and left edge sections (431, 432) of the ear platinum plated mesh (430) forms the same number of drilled holes (431A, 432A) to mate with the drilled holes (412A, 413A) of the left and right bars (412, 413) of the frame (410). The second platinum plated mesh (420) could be used either a conductive material, such as Titanium or heat resistance material, such as a polycarbonate.

The second platinum plated mesh (430) comprises a platinum plated edges (433) at both top and bottom ends, a plurality of vertical strip bars (434) and vertical strip liners (435) disposed along the Y-axis.

At the corner of the platinum plated edges (433), an electrode pad (436) is provided for attaching an electrode bar (437).

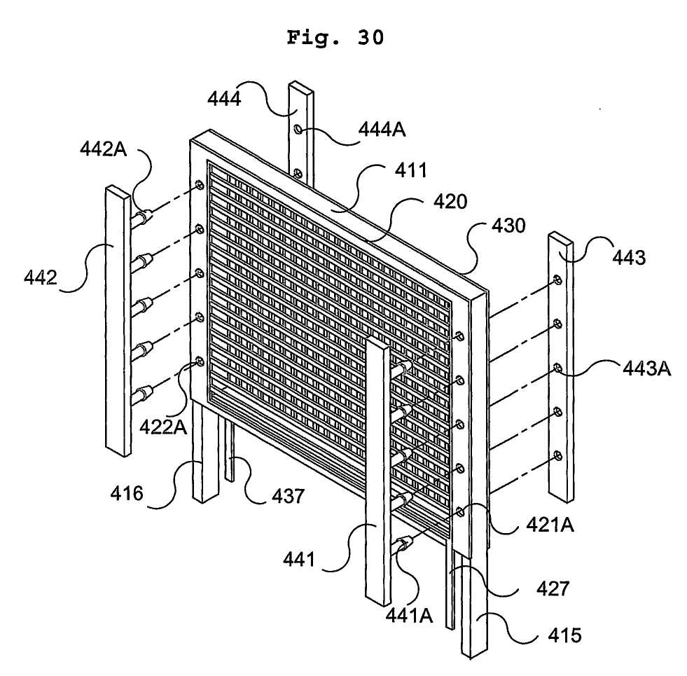

As seen in FIG. 30, the second platinum plated mesh (430) is also directly mounted on the frame (410). The drilled holes (431A, 432A) of right and left edge sections (431, 432) of the second platinum plated mesh (430) are mated with the drilled holes (412A, 413A) of the left and right bars (412, 413) of the frame (410).

Once the drilled holes (421A, 422A) of the first platinum plated mesh (420) and the drilled holes (431A, 432A) of the second platinum plated mesh (430) are mated with the drilled holes (412A, 413A) of the left and right bars (412, 413) of the frame (410), a pair of retainers (441, 442) having a plurality of pins (441A, 442A) is installed through the drilled holes (421A, 422A, 412, 413, 431A, 432A) to lock into the holes (443A, 444A) of the retainer clips (443, 444).

The first and second platinum plated meshes (420, 430) are maintained a certain constant clearance each other and formed a plurality of projected intersections of the Virtual Meshed Points “A” for performing the underwater discharge. The first and second platinum plated meshes are also possible to use the Iridium plated meshes instead of the platinum plated meshes.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An underwater discharge core comprises:
a frame having a rectangle opening,
a first platinum plate mesh made of conductive material for mounting to said frame,
an insulation plate meshes disposed over said first platinum plate meshes,
a second platinum plate mesh made of conductive material overlapped said insulation plate meshes and first platinum plate meshes.

2. An underwater discharge core as claimed in claim 1, wherein said first platinum plate mesh and second platinum plate mesh mounted on the frame are arranged to misalign square meshes.

3. An underwater discharge core as claimed in claim 2, wherein said first platinum plate mesh and second platinum plate mesh have a plurality of uniform minute square meshes, and the projected square meshes of said first and second platinum plate meshes have clearance one-half of said square meshes.

4. An underwater discharge core as claimed in claim 1, wherein said insulation plate meshes is disposed between said first platinum plate mesh and second platinum plate mesh.

5. An underwater discharge core as claimed in claim 1, further comprises that at least one side of said frame has a plurality of protrusions for mounting said first platinum plate mesh, insulation plate and second platinum plate mesh.

6. An underwater discharge core as claimed in claim 1, further comprises that at least one pair of retainer and retainer clip is installed to fix said first platinum plate mesh, insulation plate and second platinum plate on the frame.

7. (canceled)

8. (canceled)

9. (canceled)

10. (canceled)

11. (canceled)

12. (canceled)

13. An underwater discharge core as claimed in claim 1, wherein said first platinum plate mesh and second platinum plate mesh are made of the platinum group, solid Iridium, solid platinum plated Iridium or plated platinum.

14. (canceled)

15. A sterilized water generator comprises:
a container filled with water,
an underwater discharging core consisted of a rectangular-shape frame, a first and second platinum plate meshes made of conductive material, an insulation plate made of non-conductive material installed on the frame,
said container installed at least one underwater discharging core, and
a power supply unit and control system for supplying power to say first and second platinum plate mesh cells to perform underwater discharge.

16. A sterilized water generator as claimed in claim 15, wherein said container is used as a water storage tank.

17. A sterilized water generator as claimed in claim 15, wherein said container is a water flow pipeline.

18. A sterilized water generator as claimed in claim 15, further comprises:
a thermal sensor installed inside of the container for sensing operating water temperature, and
a control system to cut off the power to the underwater discharging core for preventing overheating the system based on the sensed operating water temperature.

19. A sterilized water generator as claimed in claim 15, wherein said first platinum plate mesh and second platinum plate mesh are made of the platinum group, solid Iridium, solid platinum plated Iridium or plated platinum.

20. (canceled)

21. (canceled)

22. A sterilized water supplying system comprises:
a sterilized water generator consisted of at least one underwater discharge core equipped with an alternative power supply and control system for alternatively supplying power to a set of positive and negative terminals of platinum plate meshes,
a water storage tank for storing the produced sterilized water,
a filtration unit for filtering the foreign objects from the supplied water, and
a power source/controlling unit for controlling the sterilized water generator.

23. A sterilized water supplying system as claimed in claim 22, further comprises a water pump disposed between the filtration unit and the sterilized water generator.

24. A sterilized water supplying system as claimed in claim 23, further comprises a first vale for controlling the water supply to the system by the power source/controlling unit, a second valve disposed between the sterilized water generator and the water storage tank to allow water flow one direction.

25. A sterilized water supplying system as claimed in claim 23, further comprises a thermal sensor installed inside the sterilized water generator for sensing the operating water temperature to prevent overheating the system.

26. A sterilized water supplying system as claimed in claim 23, further comprises a third valve controlled by the controlling unit for supplying the water to system, and a sensor installed inside of the water storage tank for sensing the water level.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. An underwater discharge core comprises:
a frame having a rectangular opening,
a first platinum plated mesh with X-axis or horizontal strip bars and strip liners made of plated conductive material for mounting on said frame to allow water flow, and
a second platinum plated mesh with Y-axis or vertical strip bars and strip liners made of plated conductive material for mounting opposite to said first platinum plated meshes on said frame and allowing water flow.

43. An underwater discharge core as claimed in claim 42, wherein said first platinum plated mesh and second platinum plated mesh are made of the plated platinum group, plated Iridium or plated platinum.

44. An underwater discharge core as claimed in claim 42, further comprises that at least one pair of retainer and retainer clip is installed to fix said first platinum plated mesh and second platinum plated on the frame.
